(19) United States
(12) Patent Application Publication
(10) Pub. No.: US 2004/0011144 A1
(43) Pub. Date: Jan. 22, 2004

(54) Resonator chip sensor for pressure and force with mechanically separate partial regions (slots) and a soft membrane

(76) Inventors: Claudio Cavalloni, Regensdorf (CH); Marco Gnielka, Winterthur (CH); Martin Haueis, Jena (CH)

Correspondence Address: BARNES & THORNBURG, 750-17TH STREET NW, SUITE 900, WASHINGTON, DC, 20006, US

(21) Appl. No.: 10/416,369

(22) PCT Filed: Nov. 7, 2001
(86) PCT No.: PCT/CH01/00650

(30) Foreign Application Priority Data
Nov. 15, 2000 (CH) 2223/00

(51) Int. Cl. G01L 1/04

(52) U.S. Cl. 73/862.627

(57) ABSTRACT

A sensor to reduce the loads due to different thermal expansions between a chip containing the sensing element, said chip preferably consisting of silicon, and the housing, typically made of steel, which can falsify the measuring results. The chip includes central and lateral fixations, which are mechanically decoupled from each other and are arranged on that end of the sensing element where the force application occurs.

The invention relates to a sensor according to the preamble of claim 1. The employed chip in which a sensing element is used as a resonator, is known from a report of Mr. M. Haueis on the 20^{th} International Congress of Theoretical and Applied Mechanics, Aug. 27 to Sep. 02 2000, Chicago, Ill., USA, which has been published as abstract TL1 “Single crystalline microresonator for force sensing with on-chip vibration excitation and detection”, by M. Haueis et al. A more detailed description of this sensor, the development of which is based on the object to provide a sensor for an extended temperature range of up to approx. 300° C. has been published in the paper: Haueis M. et al.: “Packaged bulk mikromachined resonant-force sensor for high-temperature applications”, SPIE-Design, Test, Integration and Packaging of MEMS/MOEMS, Paris May 2000, Vol. 4019, 2000, pp. 379-388.

The chip of this known sensor is mounted in the housing by two bolts arranged on both sides of the sensing element. It has been shown, that this sensor is sensitive to temperature variations which induce alternating tensions in the sensing element. Said temperature sensitivity is caused by different thermal expansion of chip material, which in the present case is silicon, and the housing, which generally consists of steel.

It is an object of the present invention to at least reduce said temperature sensitivity which is achieved by the features of the characterizing part of claim 1.

If the chip is connected to the housing only on one side of the sensing element both chip sides may expand to a different extent from the regions of the fixation in an unhindered manner, without thereby inducing thermal mechanical tensions in the sensing element.

For example, an advantageous embodiment is achieved if the central fixation is done by a bolt in the central leg of the chip, while the lateral fixations are ensured by the insertion of lateral legs into the slot of the housing.

To increase the stiffness of the chip in both directions perpendicular to the direction of the force application it is possible to locally connect the decoupled middle leg with the lateral legs by means of connecting links.

An exact adjustment of the chip in the direction of the force application may be achieved by means of a stopper. A further possibility resides in the orientation of the outside edges of the lateral legs in longitudinal direction parallel to the edge of the slot.

Furthermore the middle leg through which the force application is done may be preloaded relatively to the lateral legs preferably to tension to improve the linearity of the measurement results and/or to define the measurement range.

In the following, the invention is detailed with respect to an example in connection with the drawing.

In the drawings there is shown:

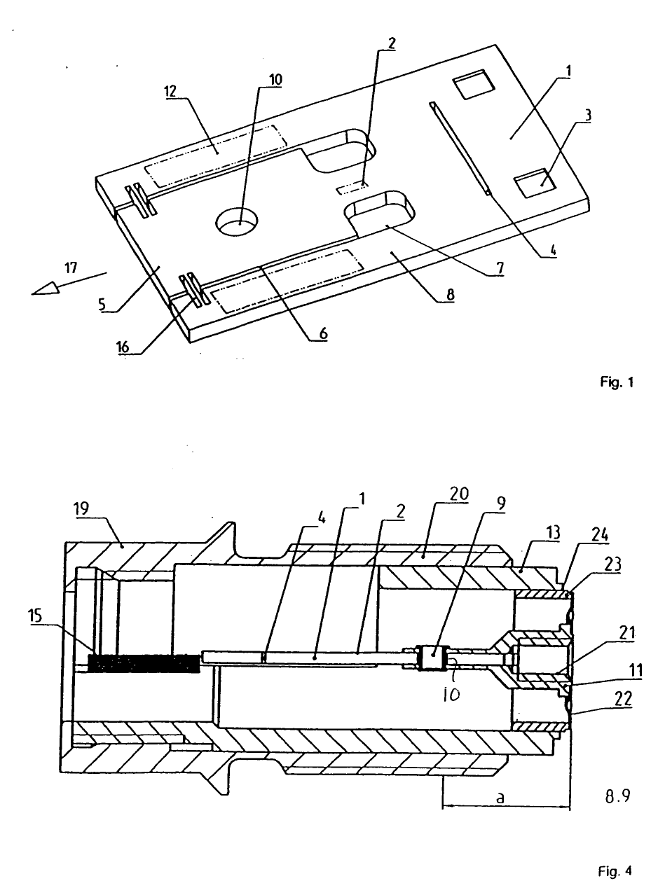

FIG. 1 a spatial illustration of the chip containing the sensing agent;

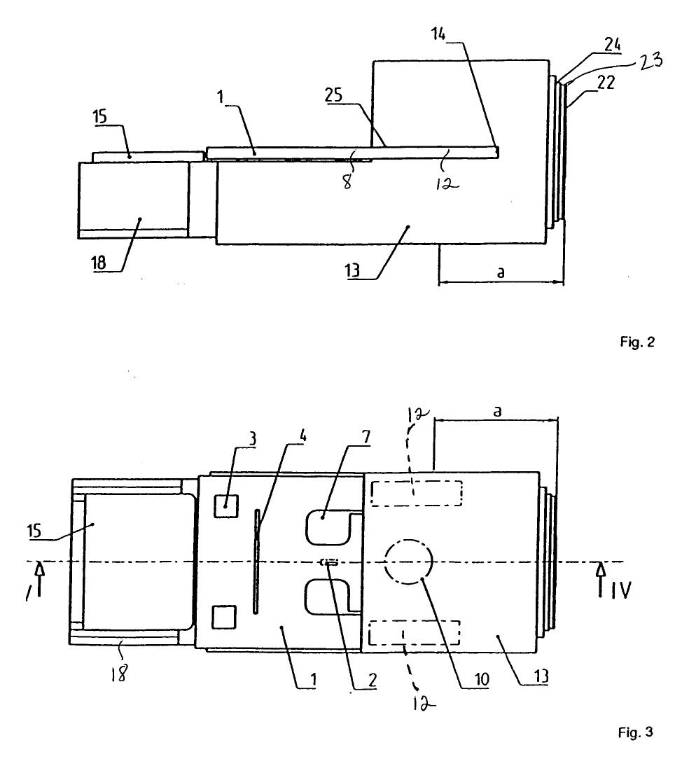

FIG. 2 a lateral view of the chip inserted into a portion of the housing;

FIG. 3 a top view of FIG. 2;

FIG. 4 a longitudinal section IV-IV of FIG. 3 through the complete sensor, i.e. completed by a second housing part;

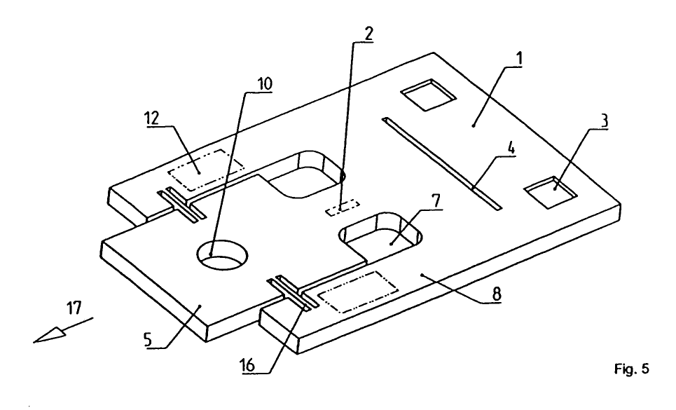

FIG. 5 in the same illustration as in FIG. 1 a second embodiment of the chip.

The sensing element of the sensor is a chip 1 (FIG. 1) consisting of three silicon wafers which are connected to each other in a gastight manner. It has been prepared in a known manner by means of the SOI technique and contains in the middle layer the actual sensing element 2, which e.g. is a micromechanical resonator, but which also may be another force-sensitive element. Thus, as a sensing element also piezoelectric or magnetorestrictive elements as well as piezoresistive or magnetoresistive resistors may e.g. be used.

In FIG. 1 contact pads 3 are indicated above sensing element 2, through which sensing element 2 is connected with the accessory electronics 15 (FIG. 2) by means of wire bonding. A slot 4 protects sensing element 2 against mechanical error loads, which e.g. may be caused by the bonded wire connections of the contact pads 3 to the electronics.

The sensing element 2 is placed in a relatively narrow strip of chip 1. Said strip which extends to a middle leg 5 including the central fixation is separated and mechanically decoupled by means of slots 6 and cavities 7 from the lateral legs 8 which themselves form the lateral fixations. It concentrates the introduced forces to the sensing element in a targeted manner.

A bolt 9 (FIG. 4) serves as a central fixation, which is inserted into a bore 10 of chip 1 with slight clearance and is connected with a sensor head 11 (FIG. 4) by flanging.

Partial areas 12 of the lateral leg 8 which are inserted into a slot 25 of a cylindrical housing part 13 (FIG. 2) and adjusted by a stopper 14 in longitudinal direction of chip 1 serve as lateral fixations. The partial areas 12 may additionally be fixed in housing part 13 by adhering or another tight connection. In both directions orthogonal to the force application 17 chip 1 is aligned by slot 25.

Sensor head 11 having an internal thread 21 (FIG. 4) for a connection with a force introducing fixation is connected at its peripheral perimeter with a steel membrane 22 which may be adjustably displaced and fixed (point 24) via membrane sleeve 23 in the housing part 13 in longitudinal direction, i.e. in the direction of the force application. By means of said displacement of the membrane 22 it is possible to adjust a certain preload at the middle leg 5 and thus at the sensing element 2 relative to the lateral legs 8 adjusted by stopper 14. As has been already mentioned said preload preferably consists of tension.

Membrane 22 is prepared relatively soft, thus achieving a high sensitivity and a decrease of the thermal errors reaching the sensing element. Moreover, by means of a soft membrane 22 the exact axial and central force application into chip 1 is improved.

The connecting links 16 bridging the slots 6 result in the fact that the elasticity of the sensor in the direction 17 of the force application is high while in the two directions perpendicular thereto there is an increased stiffness.

To minimize undesired mechanical loads on the sensing element 2 by the mechanical fixation of chip 1 in the housing 13 due to temperature alterations the thermal expansion of the components for the application of the force to be measured should be possibly of the same size such as that of the fixation of chip 1 in housing part 13 and of the force application. Preferably, this is ensured by the choice of equal materials of the components 11, 13 and interposed there between and by an equal distance a of the force application via internal thread 21 to bore 10 on the one hand and to the adhesive or clamping regions, respectively, on the partial areas 12 of the lateral fixations or to the stopper 14, respectively, on the other hand.

It should be understood that it is also possible to employ different materials having different thermal expansions for the elements 11, 13 and 23, which e.g. may be necessary due of production-technical reasons.

For this reason it is practical to have different distances of the force application at 21 to the fixations of the central fixations 9, 10 of chip 1 on the one hand and to the adhering or clamping areas 12 of the lateral fixations, respectively, on the other hand, wherein the distance of the force application/fixation of the lateral fixation relevant for the temperature expansions may also be given by stopper 14 of chip 1 in the housing parting 13.

The chip 1 for such a variant is shown in FIG. 5. Theoretically, in this chip 1 the displacement of the end of the lateral legs 8 or of the fixation areas 12 placed at stopper 14 against the location of the force application at bore 10 of the central leg 5 should correspond to the difference of the thermal expansions of the different materials for sensor head 11 on the one hand and for the membrane sleeve 23 and the housing part 13 on the other hand for the maximum required temperature range.

As may be seen from FIGS. 2 and 3 the cylindrical housing part 13 is “cut” on the left side and forms a shell the free end of which is provided with a thread 18.

A second housing part 19 (FIG. 4) is screwed thereupon, which closes the open shell of the housing part 13 and covers both the electronics 15 and chip 1. On the left side, part 19 is formed as a hexagon head for the application of a wrench. It has a thread 20 on the right side, by means of which the sensor may be screwed into an object to be measured. Moreover, due to the bipartite nature of the housing a decoupling from the object to be measured and an insensitivity against tensions is achieved which are caused by the assembly of the sensor.

As already described the housing parts 13, 19 preferably are made of steel.

Listing of the Reference Numerals

FIG. 1 and 5 1 Si chip

2 sensing element

3 contact pad

4 protecting slot

5 middle leg

6 decoupling slots

7 decoupling cavities

8 lateral legs

10 bore

12 partial area for lateral fixation

16 connecting link

17 direction of the force application

FIG. 2 and 3 13 housing part

14 stopper

15 electronics

18 thread

22 steel membrane

25 slot

a distance of force application/fixations

FIG. 4 9 bolt

11 sensor head

19 housing part

20 thread

21 internal thread

23 membrane sleeve

24 site of fixation

1. A sensor for pressure and/or force measurements, the sensing element (2) of which is arranged in a chip (1) wherein the force application in the direction (17) of its longitudinal axis occurs in a direction parallel to the surface, characterized in that central (9,10) and lateral (12) fixations are arranged on the side of the force application into the sensor in partial regions of chip (1) which are mechanically decoupled from each other.

2. The sensor according to claim 1, characterized in that chip (1) is mounted in a bipartite housing (13,19) into which the force is introduced through a relatively soft membrane (22).

3. The sensor according to claim 2, characterized in that the central fixation (9,10) is done via a bolt (9) in a middle leg (5) of chip (1), while the lateral fixations are ensured by the insertion of lateral legs (8) into a slot (25) of a sleeve-like housing element (13) wherein the force application is done axially and centrally into the middle leg (5) and the lateral fixations are formed in a symmetrical relation to the central force application (17).

4. The sensor according to claim 3, characterized in that the decoupled central and lateral legs (5,8) of chip (1) are locally connected with each other by means of connecting links (16).

5. The sensor according to any of the claims 2 to 4, characterized in that chip (1) in the housing (13, 19) is adjusted by means of a stopper (14) in the direction (17) of the force application.

6. The sensor according to any of the claims 3 and 4, characterized in that the outside edges of the lateral legs (8) are oriented in a longitudinal direction parallel to the edge of slot (25).

7. The sensor according to any of the claims 3 to 8, characterized in that the middle leg (5) serving for force application is preloaded relative to the lateral legs (8).

8. The sensor according to any of the claims 3 to 7, characterized in that the lateral legs (8) are fixed by adhering and/or clamping in housing part (13).

9. The sensor according to any of the claims 1 to 8, characterized in that the sensing element (2) is protected by at least one slot (4) against mechanical error loads on the side opposite to the fixations (9,10,12), wherein on this side the mechanical connections to the sensing element (2) are reduced to electrical contacts via wirebonds.

10. The sensor according to any of the preceding claims, characterized in that sensing element (2) is a micromachined resonator.

11. The sensor according to any of the claims 1 to 10, characterized in that the sensing element (2) consists of piezoelectric elements, magnetostrictive Elements, piezoresistive resistors or magnetoresistive resistors.

12. Sensor according to any of the preceding claims, characterized in that the distance (a) of the force application to the bore (10) for the central fixation (9,10) on the one hand and to the fixation areas (12) on the lateral fixations on the other hand are at least approximately of equal size, and that further the components (11,13,23) determining said distance (a) are consisting of the same material.
